(19) United States
(12) Patent Application Publication
(10) Pub. No.: US 2007/0043776 A1
(43) Pub. Date: Feb. 22, 2007

(54) Controller to be connected to IEEE 1394 serial bus

(75) Inventor: Junya Senoo, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/506,961

(22) Filed: Aug. 21, 2006

(30) Foreign Application Priority Data
Aug. 19, 2005 (JP) 2005-239135

(51) Int. Cl. G06F 17/30

(52) U.S. Cl. 707/200

(57) ABSTRACT

A controller to be connected via an IEEE 1394 serial bus to two or more hard disk recorders. When a user selects an attribute of program files to be deleted by using an operation unit, a microprocessor in the controller searches for program files corresponding to the attribute, which is selected by the user via the operation unit, among program files stored in any of the hard disk recorders. When program files corresponding to the selected attribute are found as a result of the search, the microprocessor creates a list of the program files corresponding to the selected attribute based on the result of the search. Then, the microprocessor sends a control command to delete each of the program files in the list from a hard disk recorder on which the each program file is stored via an IEEE 1394 interface to the hard disk recorder. Accordingly, the program files in the list are deleted from the hard disk recorders on which the program files are stored.

### BACKGROUND OF THE INVENTION

1. Field of the Invention

The present invention relates to a controller such as a set-top box to be connected to an IEEE 1394 serial bus.

2. Description of the Related Art

Today, there is increasing use of hard disk recorders (so-called audio/video hard disk drives (AVHDDs)) that can be connected to a controller such as a set-top box, a digital television receiver, or the like via an IEEE 1394 serial bus cable so as to record and reproduce data in response only to an IEEE 1394-compliant control command. For deleting program files recorded on such a hard disk recorder, a user usually operates the controller so that a list (hereinafter, referred to as “recorded program list”) of program files recorded on any of hard disks are displayed on a display unit. Then, the user selects one by one the program files to be deleted from the recorded program list before entering a command to delete the files. Therefore, the above described conventional method for deleting program files has a problem that the time needed for a user to make a deletion may increase in proportion to the number of program files to be deleted.

In the field of the above kind of devices, Japanese laid-open patent publication 2004-343520 discloses a content recording/reproduction management method of managing presentation of information to users, recording and reproducing, and so on concerning series of programs by using a series management table for the series of programs in order to reduce user effort in recording/reproducing of a series. However, for deleting program files other than series, this content recording/reproduction management method requires a user to select program files the number of times corresponding to the number of the program files to be deleted before entering a command for the deletion, like the above described conventional method. Accordingly, this method cannot solve the above described problem.

### SUMMARY OF THE INVENTION

An object of the present invention is to provide a controller to be connected to an IEEE 1394 serial bus that, when a plurality of program files stored on hard disks need to be deleted, can eliminate the need for a user to find the hard disks on which the program files to be deleted are stored and to select one by one the program files to be deleted, thereby making the deletion of the program files easy.

According to a first aspect of the present invention, this object is achieved by a controller to be connected via an IEEE 1394 serial bus to two or more hard disk recorders each capable of recording, reproducing, and deleting data in response to an IEEE 1394-compliant control command, the controller comprising: an IEEE 1394 interface for sending and receiving an IEEE 1394-compliant control command and a reply signal to the control command as well as sending and receiving stream data between the controller and the hard disk recorders; an operation unit for selecting an attribute of program files to be deleted among program files stored in any of the hard disk recorders connected via the IEEE 1394 serial bus; and a microprocessor for controlling a process of deleting program files that correspond to the attribute selected by a user via the operation unit.

When the user selects the attribute of program files by using the operation unit, the microprocessor performs: searching for program files corresponding to the attribute, which is selected by the user via the operation unit, among the program files stored in any of the hard disk recorders; when program files corresponding to the selected attribute are found as a result of the search, creating a list of the program files corresponding to the selected attribute based on the result of the search; and sending a control command to delete each of the program files in the list from a hard disk recorder on which the each program file is stored via the IEEE 1394 interface to the hard disk recorder.

With this configuration, when a user selects an attribute of program files to be deleted by using the operation unit, the microprocessor searches for program files corresponding to the attribute, which is selected by the user via the operation unit, among program files stored in any of the hard disk recorders. When program files corresponding to the selected attribute are found as a result of the search, the microprocessor creates a list of the program files corresponding to the selected attribute based on the result of the search. Then, the microprocessor sends a control command to delete each of the program files in the list from a hard disk recorder on which the each program file is stored via the IEEE 1394 interface to the hard disk recorder. Thereby, the program files in the list are deleted from the hard disk recorders on which the program files are stored. Accordingly, when a plurality of program files corresponding to the same attribute that are stored on hard disks need to be deleted, the controller can eliminate the need for a user to find the hard disks on which the program files to be deleted are stored and to select one by one the program files to be deleted before requesting the deletion, thereby making the deletion of the program files easy.

Preferably, when the attribute of program files is selected by the user via the operation unit, the microprocessor determines whether each of the program files in the list is a file already viewed or a file yet to be viewed, and deletes program files determined to be already viewed from the hard disk recorders.

Preferably, the operation unit is used to select whether to delete each of the program files in the list, and when the attribute of program files is selected by the user via the operation unit, the microprocessor determines whether each of the program files in the list is already viewed or yet to be viewed, and deletes a program file yet to be viewed from a hard disk recorder only when the program file is selected for deletion by the user via the operation unit.

According to a second aspect of the present invention, the above object is achieved by a controller to be connected via an IEEE 1394 serial bus to two or more hard disk recorders each capable of recording, reproducing, and deleting data in response to an IEEE 1394-compliant control command, the controller comprising; an IEEE 1394 interface for sending and receiving an IEEE 1394-compliant control command and a reply signal to the control command as well as sending and receiving stream data between the controller and the hard disk recorders; selection means for selecting an attribute of program files to be deleted among program files stored in any of the hard disk recorders connected via the IEEE 1394 serial bus; search means for, when a user selects the attribute of program files by using the selection means, searching for program files corresponding to the attribute, which is selected by the user via the selection means, among the program files stored in any of the hard disk recorders; list creating means for, when program files corresponding to the selected attribute are found as a result of the search by the search means, creating a list of the program files corresponding to the selected attribute based on the result of the search; and delete command sending control means for sending a control command to delete each of the program files in the list created by the list creating means from a hard disk recorder on which the each program file is stored via the IEEE 1394 interface to the hard disk recorder.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a perspective view of a set-top box that is a controller according to one embodiment of the present invention as well as AVHDDs and a digital television (DTV) that are connected to the set-top box;

FIG. 2 is an electrical block diagram of the set-top box and the AVHDDs;

FIG. 3 is a flowchart showing a process that is executed by the set-top box to delete program files having the same attribute;

FIG. 4 shows a menu to be used for requesting the above deleting process;

FIG. 5 shows a screen for selection of an attribute for the above deleting process; and

FIG. 6 shows a file list created in the deleting process.

### DESCRIPTION OF THE PREFERRED EMBODIMENTS

Referring now to the accompanying drawings, the preferred embodiment of the present invention is described. The present invention relates to a controller to be connected to a hard disk recorder via an IEEE 1394 serial bus. In the embodiment described below, the present invention is applied to a set-top box, and categories are used as an attribute for use in a search for program files to be deleted. It is to be noted that the following description of preferred embodiment of the present invention has been presented for purposes of illustration and description, and is not intended to be exhaustive or to limit the present invention to the precise form disclosed.

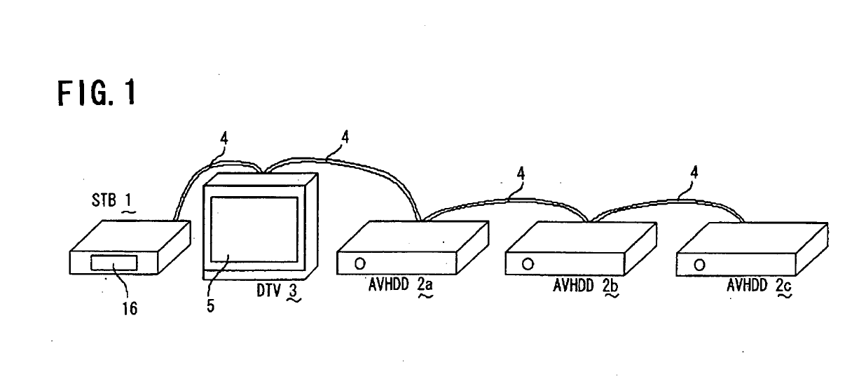

FIG. 1 shows an external view of a set-top box as well as three AVHDDs and a digital television (DTV) that are connected to the set-top box. The set-top box (hereinafter, referred to as “STB”) 1 is a device that outputs a broadcast signal on a user-selected channel among received broadcast signals. The AVHDD 2a, 2b, or 2c is a hard disk recorder of a type that is capable of recording, reproducing, and deleting data in response only to an IEEE 1394-compliant control command. A monitor 5 of the DTV 3 is used to display, for example, a list of program files stored in the AVHDDs 2a, 2b, and 2c. As shown in FIG. 1, the STB 1 has a display 16 for displaying e.g. various messages at the front side. The STB 1 and the DTV 3, the DTV 3 and the AVHDD 2a, the AVHDD 2a and the AVHDD 2b, and the AVHDD 2b and the AVHDD 2c are connected by IEEE 1394 serial bus cables 4. More particularly, the STB 1, the DTV 3 and the AVHDDs 2a, 2b, and 2c are daisy-chained. In this embodiment, the AVHDDs 2a, 2b, and 2c can perform operations such as recording, reproduction, and deletion in response only to IEEE 1394-compliant control commands sent from the STB 1.

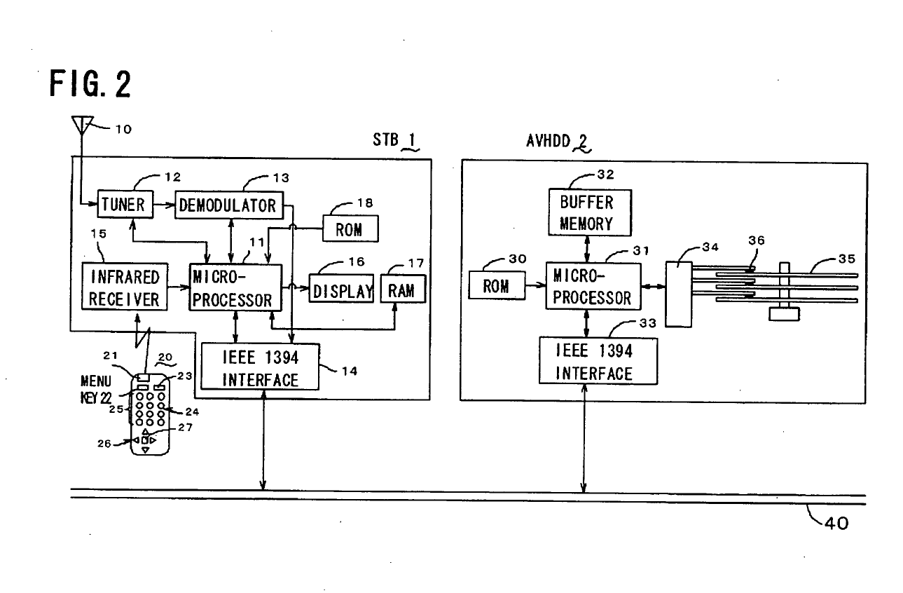

Referring now to FIG. 2, the electrical configuration of the STB 1 and the AVHDDs 2a, 2b, and 2c is described. In FIG. 2, the AVHDDs 2a, 2b, and 2c in FIG. 1 are shown collectively as the AVHDD 2. The STB 1 comprises a microprocessor 11 (claimed delete command sending control means, search means, list creating means, and viewing determination means) that controls each component therein. The microprocessor 11 is connected to the display 16, a tuner 12, a demodulator 13, an IEEE 1394 interface 14 (hereinafter referred to simply as “interface”), an infrared receiver 15, a RAM 17, and a ROM 18.

The tuner 12 extracts a broadcast signal on a user-selected channel from broadcast signals received through an antenna 10. The demodulator 13 demodulates the broadcast signal extracted by the tuner 12 in accordance with the broadcasting method. The interface 14 is an interface circuit for sending and receiving data between the STB and other devices on an IEEE 1394 serial bus (hereinafter referred to simply as “bus”) 40. The interface 14 sends and receives data to and from the AVHDD 2 and the DTV 3 (see FIG. 1) via the bus 40. The infrared receiver 15 receives an infrared command signal transmitted from a remote control 20 (claimed operation unit and selection means) and converts the command signal into a standard digital signal for output to the microprocessor 11. The RAM 17 temporarily stores data such as a list of program files stored in the AVHDD 2. The ROM 18 stores various menus, control programs, and so on.

The remote control 20 has an infrared transmitter 21 and a key portion 24, where arranged are various keys such as a power key 23, numeric keys 25, cursor keys 26, an enter key 27, and a menu key 22 for causing various menus to be displayed. The keys on the remote control 20 are used, for example, to make selections using various menu screens, to select an attribute for deletion that is displayed on the monitor 5 of the DTV 3, and to select a program file to be deleted from a program file list.

The AVHDD 2 comprises a microprocessor 31 for controlling each component therein, a ROM 30 for storing control programs for the microprocessor 31, and an IEEE 1394 interface (hereinafter referred to simply as “interface”) 33 for receiving data such as a control command and stream data from the STB 1 or other device via the bus 40. The AVHDD 2 further comprises a plurality of hard disks 35 on which data is recorded, a plurality of magnetic heads 36 for recording and reading data on and from the hard disks 35, a head drive unit 34 for driving the magnetic heads 36, and a buffer memory 32 for temporarily storing data to be recorded or data read.

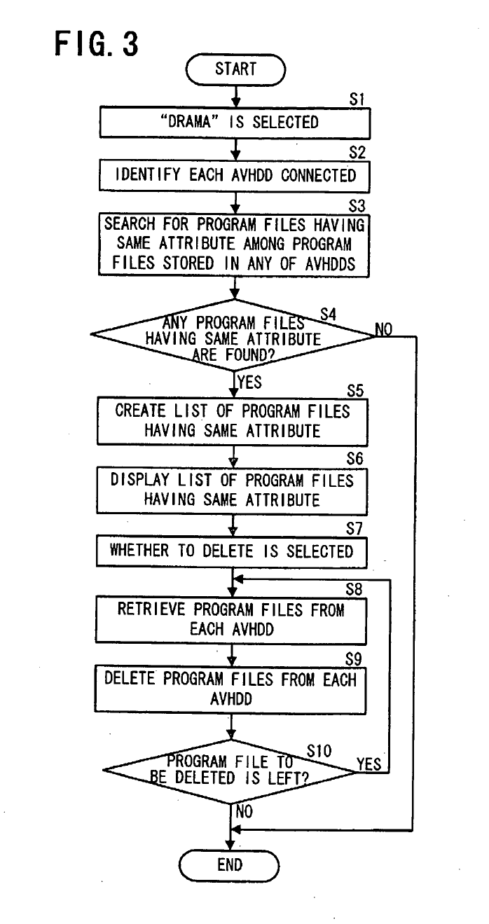

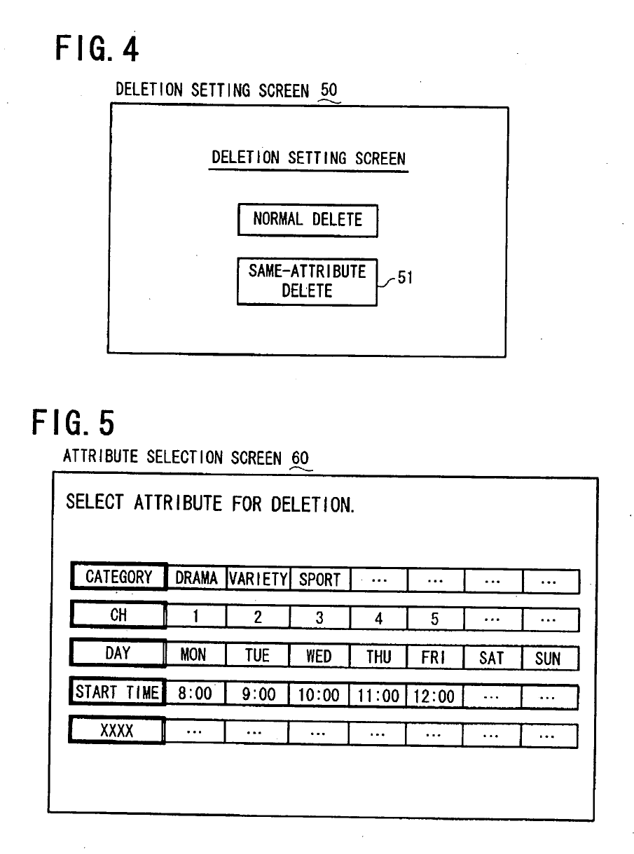

Referring now to the flowchart of FIG. 3 as well as FIG. 4 to FIG. 6, the process of deleting program files having the same attribute among program files stored in the AVHDDs 2a, 2b, and 2c is described. This process starts when a user operates the remote control 20 to display a deletion setting screen 50 as shown in FIG. 4 on the monitor 5 of the DTV 3 and select a same-attribute delete button 51. In response to the selection, the microprocessor 11 of the STB 1 displays an attribute selection screen 60 for selection of an attribute of program files on the monitor 5 of the DTV 3 so as to prompt the user to select an attribute for deletion as shown in FIG. 5.

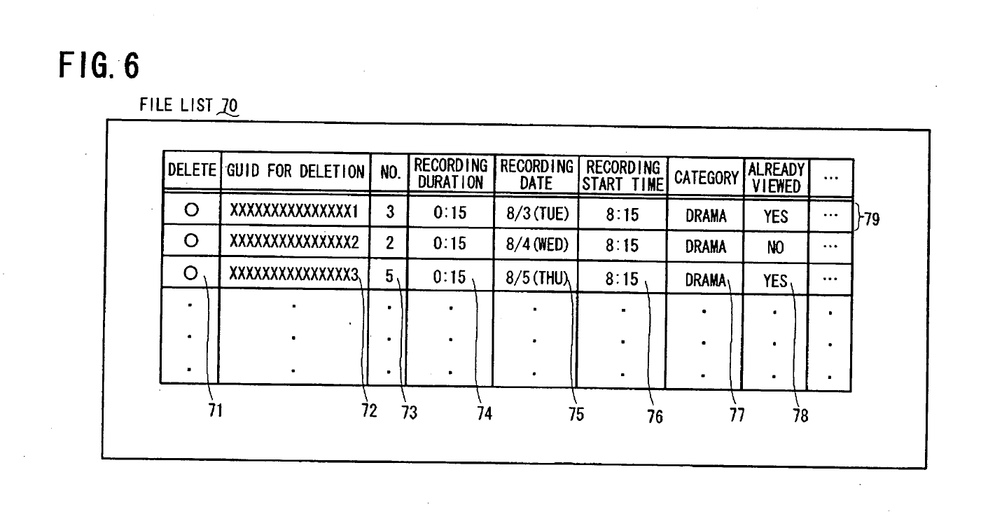

For example, assume that a user selects a category “drama” as an attribute of program files to be deleted. When the user selects “drama” among categories by using the remote control 20 (S1), the microprocessor 11 of the STB 1 identifies each of the AVHDDs 2a, 2b, and 2c connected to the STB 1 (S2), and searches for all program files having the same attribute as the attribute selected at the step S1 among program files stored in any of the AVHDDs 2a, 2b, and 2c (S3). If any program files having the same attribute are found as a result of the search (YES at S4), the microprocessor 11 of the STB 1 creates a list (file list 70 shown in FIG. 6) of the program files having the same attribute (S5), and stores the list in the RAM 17. On the other hand, if no program file having the same attribute is found (NO at S4), the microprocessor 11 exits the process without performing subsequent steps.

Now, data contained in each record 79 in the above described file list 70 is described. Each record 79 in the file list 70 contains data such as information 71 as to whether or not the program file is to be deleted, an ID (GUID for deletion) 72 unique to the AVHDD 2a, 2b, or 2c on which the program file is stored, a file number (the number of the program file stored in the AVHDD 2a, 2b, or 2c) 73, a duration 74 of the recording of the program file, a (start) date 75 of the recording of the program file, a start time 76 of the recording of the program file, a category 77 of the program file, information 78 as to whether or not the program file has been already viewed, and so on.

After completing the process of creating the file list 70, the microprocessor 11 of the STB 1 displays the file list 70, which is the list of the program files having the same attribute, on the monitor 5 of the DTV 3 (S6). Then, the user can select whether to delete even a program file yet to be viewed, by using the remote control 20 (S7). This embodiment is designed so that a program file already viewed is deleted but whether to delete a program file yet to be viewed can be selected by a user. However, this is only an example, and can be modified so that no program file yet to be viewed is deleted. It is also possible to prevent deletion of a locked program file even when the program file is one already viewed.

Subsequently, the microprocessor 11 of the STB 1 retrieves the program files to be deleted among the program files stored in the AVHDDs 2a, 2b, and 2c (S8) and deletes the program files (S9). Then, if there is no more program file to be deleted (NO at S10), the microprocessor 11 exits the process. On the other hand, if a program file to be deleted is left (YES at S10), the microprocessor 11 repeats the steps S8 and S9.

As described above, according to the STB 1 of this embodiment, by just selecting an attribute for deletion via the remote control 20, a user can cause the STB 1 to identify all the AVHDDs 2a, 2b, and 2c, search for program files having the same attribute as the selected attribute, and create the list 70 as a result of the search for display. Then, by selecting program files to be deleted via the remote control 20, the user can cause the STB 1 to delete all the program files selected for deletion. Accordingly, when deleting a plurality of program files stored in the AVHDD 2, the STB 1 can eliminate the need for a user to find the AVHDD 2 on which each of the program files to be deleted is stored and to select one by one the program files to be deleted before deletion. Thereby, the STB 1 can make it easy for a user to delete program files.

The present invention has been described above using a presently preferred embodiment, but those skilled in the art will appreciate that various modifications are possible. Accordingly, all such modifications are intended to be included within the spirit and scope of the present invention. For example, categories are used as the attribute in the above described embodiment, but other kinds of data, e.g., channel, day of a week, or start time, that program files stored in the AVHDD 2 commonly have can be also used as an attribute.

Further, shown in the above embodiment is the process of deleting program files having the same attribute as an attribute selected by a user. Alternatively, it is possible to delete program files having an attribute other than an attribute selected by a user, for example.

The present invention is applied to the STB 1 in the above described embodiment, but it can be applied to another controller such as a digital television receiver, a DVD recorder, a hard disk recorder, or the like. The hard disk recorder connected to the STB 1 via the IEEE 1394 serial bus 40 is not necessarily the AVHDD used in the above described embodiment but can be a common hard disk recorder. Further, in the above embodiment, three AVHDDs are connected to the STB 1 via the IEEE 1394 serial bus 40, but two or more than three AVHDDs can be connected to the STB.

This application is based on Japanese patent application 2005-239135 filed Aug. 19, 2005, the contents of which are hereby incorporated by reference.

What is claimed is:

1. A controller to be connected via an IEEE 1394 serial bus to two or more hard disk recorders each capable of recording, reproducing, and deleting data in response to an IEEE 1394-compliant control command, the controller comprising:
an IEEE 1394 interface for sending and receiving an IEEE 1394-compliant control command and a reply signal to the control command as well as sending and receiving stream data between the controller and the hard disk recorders;
an operation unit for selecting an attribute of program files to be deleted among program files stored in any of the hard disk recorders connected via the IEEE 1394 serial bus; and
a microprocessor for controlling a process of deleting program files that correspond to the attribute selected by a user via the operation unit,
wherein when the user selects the attribute of program files by using the operation unit, the microprocessor performs:
searching for program files corresponding to the attribute, which is selected by the user via the operation unit, among the program files stored in any of the hard disk recorders;
when program files corresponding to the selected attribute are found as a result of the search, creating a list of the program files corresponding to the selected attribute based on the result of the search; and
sending a control command to delete each of the program files in the list from a hard disk recorder on which the each program file is stored via the IEEE 1394 interface to the hard disk recorder.

2. The controller according to claim 1, wherein when the attribute of program files is selected by the user via the operation unit, the microprocessor determines whether each of the program files in the list is a file already viewed or a file yet to be viewed, and deletes program files determined to be already viewed from the hard disk recorders.

3. The controller according to claim 2,
wherein the operation unit is used to select whether to delete each of the program files in the list, and
wherein when the attribute of program files is selected by the user via the operation unit, the microprocessor determines whether each of the program files in the list is already viewed or yet to be viewed, and deletes a program file yet to be viewed from a hard disk recorder only when the program file is selected for deletion by the user via the operation unit.

4. The controller according to claim 3, wherein the controller is a set-top box.

5. The controller according to claim 1, wherein the controller is a set-top box.

6. A controller to be connected via an IEEE 1394 serial bus to two or more hard disk recorders each capable of recording, reproducing, and deleting data in response to an IEEE 1394-compliant control command, the controller comprising:
an IEEE 1394 interface for sending and receiving an IEEE 1394-compliant control command and a reply signal to the control command as well as sending and receiving stream data between the controller and the hard disk recorders;
selection means for selecting an attribute of program files to be deleted among program files stored in any of the hard disk recorders connected via the IEEE 1394 serial bus;
search means for, when a user selects the attribute of program files by using the selection means, searching for program files corresponding to the attribute, which is selected by the user via the selection means, among the program files stored in any of the hard disk recorders;
list creating means for, when program files corresponding to the selected attribute are found as a result of the search by the search means, creating a list of the program files corresponding to the selected attribute based on the result of the search; and
delete command sending control means for sending a control command to delete each of the program files in the list created by the list creating means from a hard disk recorder on which the each program file is stored via the IEEE 1394 interface to the hard disk recorder.

7. The controller according to claim 6, further comprising viewing determination means for determining whether each of the program files in the list is a file already viewed or a file yet to be viewed when the attribute of program files is selected by the user via the selection means,
wherein the delete command sending control means sends, to a hard disk recorder, a control command to delete a program file determined by the viewing determination means as being already viewed from the hard disk recorder.

8. The controller according to claim 7,
wherein the selection means is used to select whether to delete each of the program files in the list, and
wherein the delete command sending control means deletes, from a hard disk recorder, a program file determined by the viewing determination means as being yet to be viewed only when the program file is selected for deletion by the user via the selection means.

9. The controller according to claim 8, wherein the controller is a set-top box.

10. The controller according to claim 6, wherein the controller is a set-top box.
